(19) United States
(12) Patent Application Publication
(10) Pub. No.: US 2001/0029126 A1
(43) Pub. Date: Oct. 11, 2001

(54) Securing device for immobilizing plural electric wires

(76) Inventors: Hung-Chi Chen, Taoyuan Shien (TW); Henry Chang, Taoyuan Shien (TW); Dwo Chen, Taoyuan Shien (TW)

Correspondence Address: Pillsbury Winthrop LLP, 2550 Hanover Street, Palo Alto, CA, 94304-1115, US

(21) Appl. No.: 09/815,926

(22) Filed: Mar. 22, 2001

(30) Foreign Application Priority Data
Apr. 7, 2000 (TW) 89205572

(51) Int. Cl. H01R 13/58

(52) U.S. Cl. 439/449

(57) ABSTRACT

A securing device for immobilizing plural electric wires is disclosed. The securing device includes a supporting member having plural concavities thereon for allowing the plural electric wires to be placed therein, and a capping member having one end pivotally connected to one end of the supporting member for capping the supporting member, thereby immobilizing the plural electric wires when each of the plural electric wires is placed in a corresponding concavity of the supporting member. The plural electric wires are connected to a plug which is plugged in a socket of a printed circuit board. The supporting member further includes a first engaging element disposed in the other end thereof, and the capping member further includes a second engaging element disposed in the other end thereof for engaging with the first engaging element of the supporting member.

### FIELD OF THE INVENTION

The present invention is related to a securing device for immobilizing plural electric wires, and more particularly to a securing device for immobilizing plural electric wires applied in an electronic device.

### BACKGROUND OF THE INVENTION

Generally, there are many types of electric wires disposed in an electronic device for transmitting electric current or signals. For example, the conducting lines connecting to the power supply of a personal computer are used for providing different electric voltages, e.g. 5V, 12V, GND, −5V and −12V, to different peripheral devices once the personal computer is turned on. Certainly, a securing device disposed in a recession of the power supply is required for immobilizing the plural conducting lines. Because of immobilization of the plural conducting lines, the plural conducting lines are kept orderly from making a mess.

Please refer to FIG. 1 which is a schematic diagram showing how a securing device immobilizes plural electric wires which connect to an electronic device according to the prior art. The electronic device includes an upper cover 17, a lower casing 12 and a printed circuit board 13. The printed circuit board 13 is mounted in the lower casing 12 for electrically connecting with plural electric wires 18. More specifically, the plural electric wires 18 are connected to a plug 10, which is plugged into a socket 14 of the printed circuit board 13. According to the prior art, the plural electric wires 18 are strapped by a strapping member 19. Once the upper cover 17 and the lower casing 12 are assembled with the securing device 11, the plural electric wires 18 strapped by the strapping member 19 are immobilized by the securing device 11 which is disposed in a recession 15 of the lower casing 12.

However, according to the prior art, the conventional securing device has some disadvantages as follows.

1. Because the electric wires 18 are strapped together by the strapping member 19, heat produced by the electric wires 18 is hard to be dissipated.

2. If one of the electric wires 18 is damaged, it's troublesome for one to recognize the right electric wire which we intend to replace with another one. In addition, because the electric wires 18 are strapped by the strapping member 19, it's also difficult for one to disassemble the strapped electric wires 18.

3. Each electric wire sustains different extent of strength. The sheathing for preventing the inner conductor of an electric wire from short-circuiting with that of another electric wire is easily to be rubbed off.

Accordingly, it is attempted by the present invention to solve the problems encountered in the prior arts as described above.

### SUMMARY OF THE INVENTION

An object of the present invention is to provide a securing device for immobilizing plural electric wires applied in an electronic device.

Another object of the present invention is to provide a securing device for improving the heat-dissipating efficiency of plural electric wires applied in an electronic device.

A further object of the present invention is to provide a securing device for prevent the sheathing of plural electric wires from being rubbed off easily.

According to one aspect of the present invention, the present invention is related to a securing device for immobilizing plural electric wires. The securing device comprises a supporting member having plural concavities thereon for allowing the plural electric wires to be placed therein, and a capping member having one end pivotally connected to one end of the supporting member for capping the supporting member, thereby immobilizing the plural electric wires when each of the plural electric wires is placed in a corresponding concavity of the supporting member.

Preferably, the plural electric wires are connected to a plug which is plugged in a socket of a printed circuit board.

Preferably, the supporting member further includes a first engaging element disposed in the other end thereof, and the capping member further includes a second engaging element disposed in the other end thereof for engaging with the first engaging element of the supporting member.

According to another aspect of the present invention, the present invention is related to an assembled unit for immobilizing plural electric wires. The assembled unit comprises an upper cover, a lower casing adapted to be covered with the upper cover and having a recession disposed on one side thereof, a printed circuit board mounted in the lower casing for electrically connecting with the plural electric wires, and a securing device disposed in the recession of the lower casing for immobilizing the plural electric wires, wherein the securing device comprises a supporting member having plural concavities thereon for allowing the plural electric wires to be placed therein, and a capping member having one end pivotally connected to one end of the supporting member for capping the supporting member, thereby immobilizing the plural electric wires when each of the plural electric wires is placed in a corresponding concavity of the supporting member.

Preferably, the plural electric wires are connected to a plug.

Preferably, the printed circuit board further includes a socket for being plugged with the plug.

### BRIEF DESCRIPTION OF THE DRAWING

The present invention may best be understood through the following description with reference to the accompanying drawings, in which:

FIG. 1 is a schematic diagram showing how a securing device immobilizes plural electric wires which connect to an electronic device according to the prior art; and

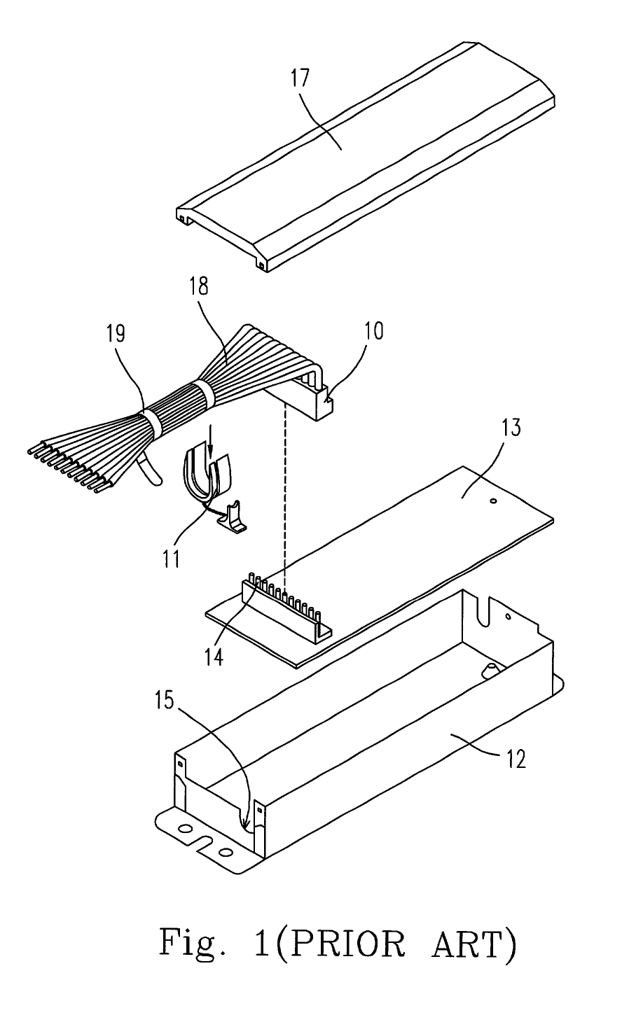

FIG. 2 is a schematic diagram showing how a securing device immobilizes plural electric wires which connect to an electronic device according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

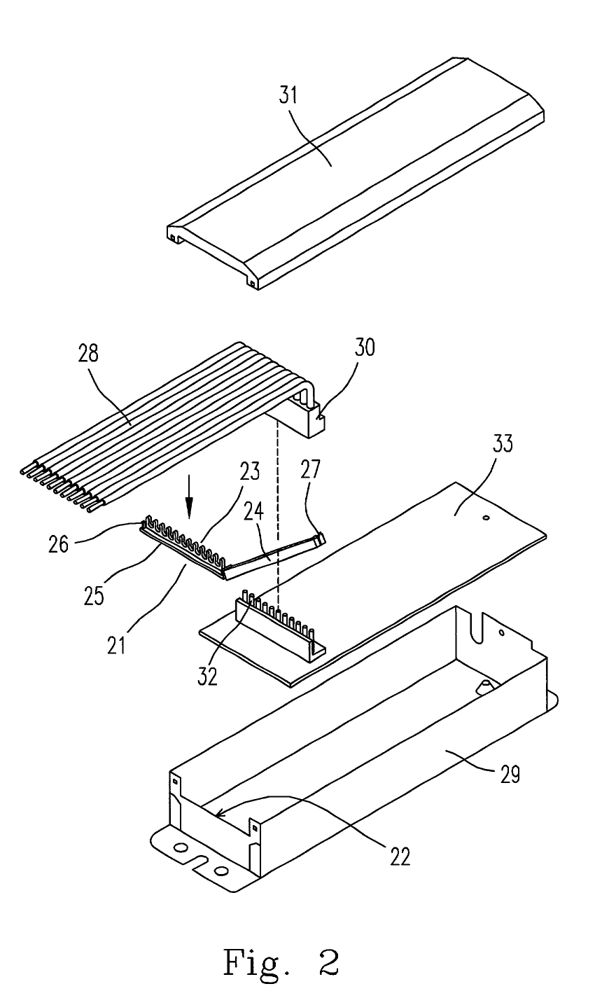

Please refer to FIG. 2 which is a schematic diagram showing how a securing device immobilizes plural electric wires which connect to an electronic device according to the present invention. The electronic device includes an upper cover 31, a lower casing 29 and a printed circuit board 33. The printed circuit board 33 is mounted in the lower casing 29 for electrically connecting with plural electric wires 28. More specifically, the plural electric wires 28 are connected to a plug 30, which is plugged into a socket 32 of the printed circuit board 33. Once the upper cover 31 and the lower casing 29 are assembled with the securing device 21, the plural electric wires 28 are immobilized by the securing device 21 which is disposed in a recession 22 of the lower casing 29. According to the present invention, the securing device 21 includes a supporting member 25 having plural concavities 23 thereon for allowing the plural electric wires 28 to be placed therein, and a capping member 24 having one end pivotally connected to one end of the supporting member 25 for capping the supporting member 25, thereby immobilizing the plural electric wires 28 when each of the plural electric wires 28 is placed in a corresponding concavity 23 of the supporting member 25. Preferably, the supporting member 25 further includes a first engaging element 26 disposed in the other end thereof, and the capping member 24 further includes a second engaging element 27 disposed in the other end thereof for engaging with the first engaging element 26 of the supporting member 25.

Therefore, according to the present invention, because the plural electric wires are orderly disposed in parallel with one another, heat produced by the electric wires can be efficiently dissipated. In addition, the electric wires can be apparently recognized, and it's hard for the sheathing of each electric wire to be rubbed off. Thus, the problems encounter in the prior arts are solved.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A securing device for immobilizing plural electric wires, comprising:
a supporting member having plural concavities thereon for allowing said plural electric wires to be placed therein; and
a capping member having one end pivotally connected to one end of said supporting member for capping said supporting member, thereby immobilizing said plural electric wires when each of said plural electric wires is placed in a corresponding concavity of said supporting member.

2. The securing device according to claim 1, wherein said plural electric wires are connected to a plug which is plugged in a socket of a printed circuit board.

3. The securing device according to claim 1, wherein said supporting member further includes a first engaging element disposed in the other end thereof, and said capping member further includes a second engaging element disposed in the other end thereof for engaging with said first engaging element of said supporting member.

4. An assembled unit for immobilizing plural electric wires, comprising:
an upper cover;
a lower casing adapted to be covered with said upper cover and having a recession disposed on one side thereof;
a printed circuit board mounted in said lower casing for electrically connecting with said plural electric wires; and
a securing device disposed in said recession of said lower casing for immobilizing said plural electric wires,
wherein said securing device comprises:
a supporting member having plural concavities thereon for allowing said plural electric wires to be placed therein; and
a capping member having one end pivotally connected to one end of said supporting member for capping said supporting member, thereby immobilizing said plural electric wires when each of said plural electric wires is placed in a corresponding concavity of said supporting member.

5. The assembled unit according to claim 4, wherein said plural electric wires are connected to a plug.

6. The assembled unit according to claim 5, wherein said printed circuit board further includes a socket for being plugged with said plug.
